(19) United States
(12) Patent Application Publication
(10) Pub. No.: US 2004/0237748 A1
(43) Pub. Date: Dec. 2, 2004

(54) Punch

(76) Inventors: Klaus Potthoff, Vaxjo (SE); Per Hermannsson, Vaxjo (SE)

Correspondence Address: DAVIS & BUJOLD, P.L.L.C., FOURTH FLOOR, 500 N. COMMERCIAL STREET, MANCHESTER, NH, 03101-1151, US

(21) Appl. No.: 10/490,610

(22) PCT Filed: Sep. 27, 2002
(86) PCT No.: PCT/SE02/01773

(30) Foreign Application Priority Data
Sep. 27, 2001 (SE) 0103227-5

(51) Int. Cl. B26F 1/14

(52) U.S. Cl. 83/684

(57) ABSTRACT

A punch (1) with a shell (2) having an insertion opening (35) for material, which is to be punched, and punching pins (26) in connection with the opening as well as a lever mechanism (55), driven by an electric motor and designed to transmit punching force to the punching pins, which motor drives a gear reduction set with a small gear wheel (66) and a large driven gear wheel (64). An eccentric shaft (62) is eccentrically mounted in the latter wheel with concentric pins (63) in relation to the driven wheel, which concentric pins are mounted in the shell (2). The eccentric shaft (62) is surrounded by mounting eyes at its one end by swinging arms (61), the other end of which is mounted on a flexible shaft (58) between the one longitudinal side by an upper, in the shell rotatably fastened link (59), to which via the flexible shaft (58) the one longitudinal side of an intermediate link (59) is rotatably connected, the other longitudinal side of which via a flexible shaft (56) is connected to a positively guided punch holding list (50), which can be displaced between an upper starting position and a lower punching position and supports the punching pins (26), which are guided in a profile (24), which includes the insertion opening (35). The links are in a mutually stretched out position in the punching position of the punching pins and a mutually angular position in their starting position.

The present invention relates to a punch of the type set forth in the preamble of claim 1.

Such punches are used to punch holes in a marginal area on separate sheets of paper or sheaves of papers, which later are filed in binders or are prepared to be filed.

Known punches usually are designed for manual punching of holes in up to only a few sheets of paper at a time. Thus, thick sheaves of papers must be divided up into smaller sheaves, which is a drawback due to the fact, that it is time-consuming and also displacements between several sheaves of papers may occur. Sometimes it is possible, but not without inconvenience, to break the holding together of thick sheaves of papers, e.g. when seals, bindings and the like are used.

Only a few sheets of paper require relatively large forces for a punching. It may be difficult for weak and/or disabled persons to develop these forces. Suitable electrically driven punches are not known so far. Known punches are often too weak and also ergonomically designed in an improper way. The transmission of power from the handle maybe is not very appropriate. In order to punch a hole with the usual diameter through an e.g. 9 mm thick sheaf of papers, a punching force of about 2000 N is required. Since the normal Swedish punching includes 4 holes, a punching force of about 8000 N is required. This force cannot reasonably be developed manually. In case the use of a driving motor is contemplated, it would be inappropriate to design a driving motor for this large force or even larger forces, since such large forces, acting directly, would require a very strong and heavy motor, requiring a lot of space, etc., which would result in an over-sized and unwieldy punch.

Another drawback may reside in the fact, that different punching patterns maybe are required for different purposes. For each such pattern a special punch is required, which maybe is inconvenient and expensive.

The disposal of the punching waste material maybe can result in difficulties and worn out punching pins may result in impaired hole qualities. A replacement of punching pins usually is not considered and consequently the entire punch is discarded, if one or several pins are bad.

Also, when using known punches, it is necessary to carefully insert the papers and sheaves of papers respectively. They easily end up in a somewhat oblique position, which results in an oblique filing in binders. Appliances which far-reachingly guarantee a faultless punching position are not known or in use so far.

Also, a complicated interplay of a number of operations has to take place in the already known punches in order to carry out a faultless punching. Partly a sheaf of papers must e.g. be kept with one hand. Partly this hand, which carries on the important holding function, must see to it, that no displacements take place between the separate sheets of paper. Partly the other hand must operate the handle of the punch. And partly the same hand must see to it, that the punch remains in its position, at least until the punching operation has begun. Also, if the sheaves of papers are thick, the forces of both hands are often required in order to press down the handle. The hand which holds the sheaf of papers, then must let go of the sheaf of papers, which means, that the sheaf of papers usually is subjected to bending forces, because the sheaf with certain portions thereof hangs down over the outline of the punch. Then displacements can of course occur, if a strong and uniform pressure is not maintained.

As far as, as is the case in similar technical fields, particularly in the engineering industry, punches and presses are already known, they usually are large, heavy and requires a lot of space and already for this reason they are not suitable as punches particularly for office use. Also, despite particularly a bulky design such punches and presses are not very suitable for punching a row of holes, i.e. the transmission of power mechanism is designed for spot punching. One instance of this is U.S. Pat. No. 5,916,345, in which various components, which are used for the transmission of power, are extensive and include several stationary control means and a transmission of power from a large driven gear wheel, suitable only for spot purposes. Said components must be made relatively strong in order to receive lateral forces and in order to not be deformed, when relatively large forces are transmitted.

The same is true for another technique, which is described in U.S. Pat. No. 5,588,344, in which certainly a transmission of power mechanism, more suitable for a compact design, is provided, which however requires large directly acting, i.e. rectilinear forces, which it may be difficult to supply and which subject some of the components in the mechanism to large stresses respectively. A construction solution according to EP 0 536 804 certainly is an improvement in this regard compared to the US PS, mentioned above, but this is also designed for a point-shaped action and is a component of the power transmission mechanism, which is identical to the mechanism described in the above-mentioned US PS. U.S. Pat. No. 3,979,980 also relates to a point-shaped transmission of power and it particularly relates to a protection mechanism for a press. A punch with an interchangeable punch pin device for punching in sheaves of papers for spiral winding pads is described in U.S. Pat. No. 5,771,768, which however neither shows nor describes any particular driving and power transmission mechanism. In the first paragraph of the detailed description it is only stated, that such a mechanism can be designed in various ways according to what is known in the art.

The object of the present invention is to counteract and as far as possible eliminate the above-mentioned drawbacks. Also, an object of the invention is to further develop the state of the art in this field in various ways.

These objects are attained according to the invention by designing a punch of the type described in the introduction mainly as set forth in the characterizing clause of claim 1. Such a punch can eliminate all the drawbacks described above. Such a punch can e.g. easily punch a sheaf of 80-100 sheets of papers, substantial security requirements being met. Much larger sheaves of papers can also be punched, but additional security measures must be taken in order to always avoid the risks, that hand or fingers may be injured. The punch can easily be provided with a mechanical and/or a photoelectric trigger mechanism, which initiates a punching operation. All that is required for a punching is the insertion of a sheaf of papers in an opening in the punch, in which the punching tools are active. In this opening said trigger mechanism can also be mounted, which automatically triggers the punching, when e.g. a light beam to a photoelectric cell has been interrupted and/or a mechanical sensor has been actuated. When sheaves of papers are inserted in said opening, the sheaf of papers suitably is displaced along an inclined surface, the force of gravity being used to automatically obtain a completely inserted end position or to facilitate such an insertion, which end position is identical to the punching position. Thanks to the concept of develop the transmission of power progressively by means of a crank shaft, driving rods and a toggle joint, a driving motor with a limited capacity is sufficient, which means, that the entire punch can obtain a smaller weight, smaller dimensions and generally become relatively easy to handle.

Additional characterizing features and advantages of the invention are set forth in the following description, reference being made to the accompanying drawings, which depict a few preferred but not limiting embodiments, In the drawings:

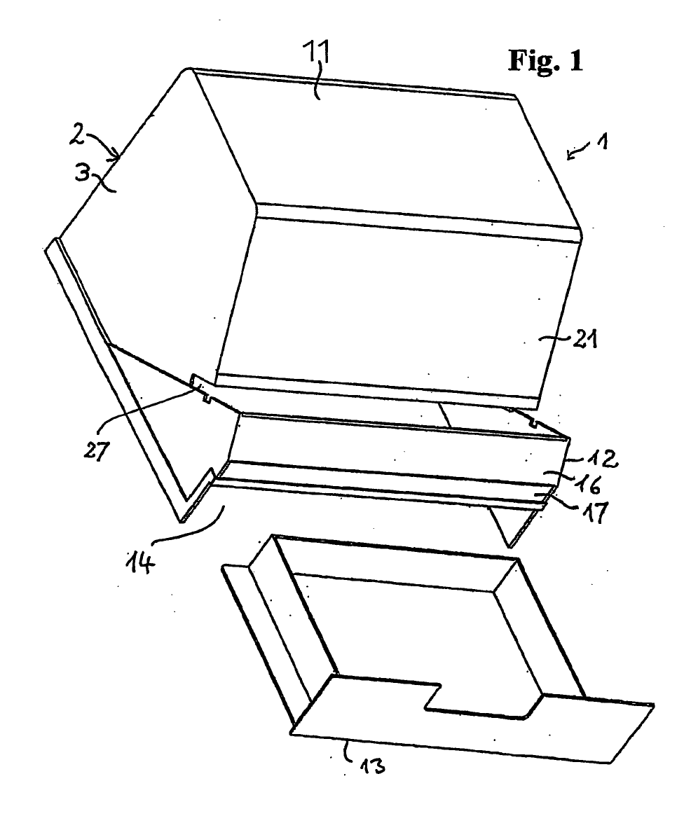

FIG. 1 is a perspective view from above of a preferred embodiment of a punch according to the invention

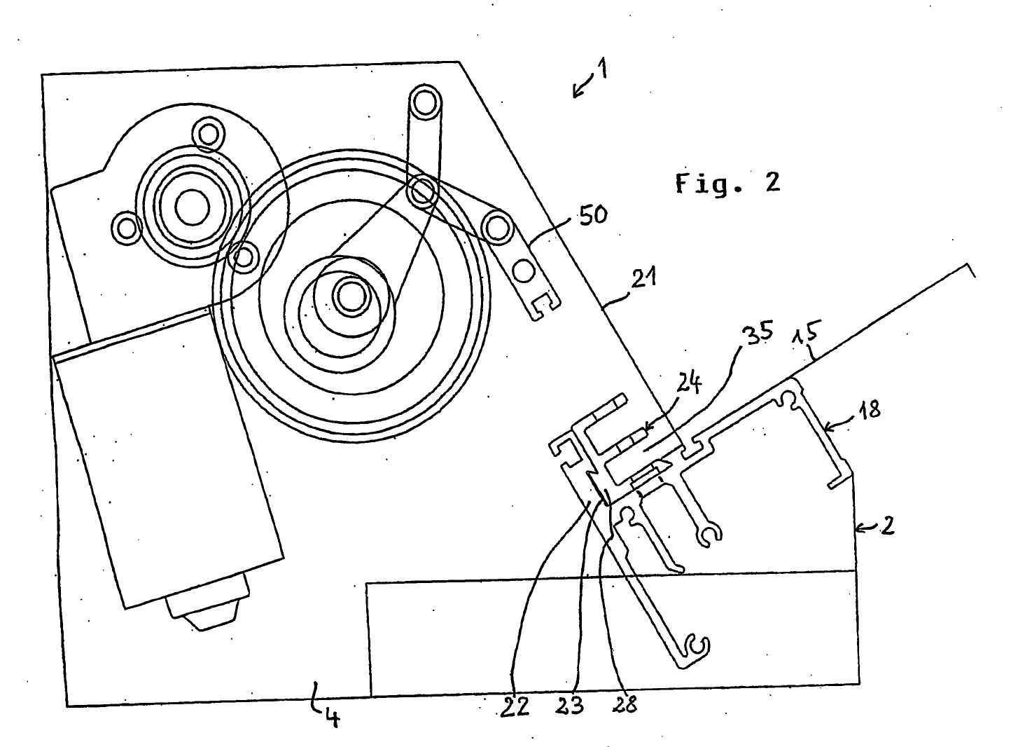

FIG. 2 a lateral view of the punch according to FIG. 1, with a removed side wall in order to elucidate the functioning;

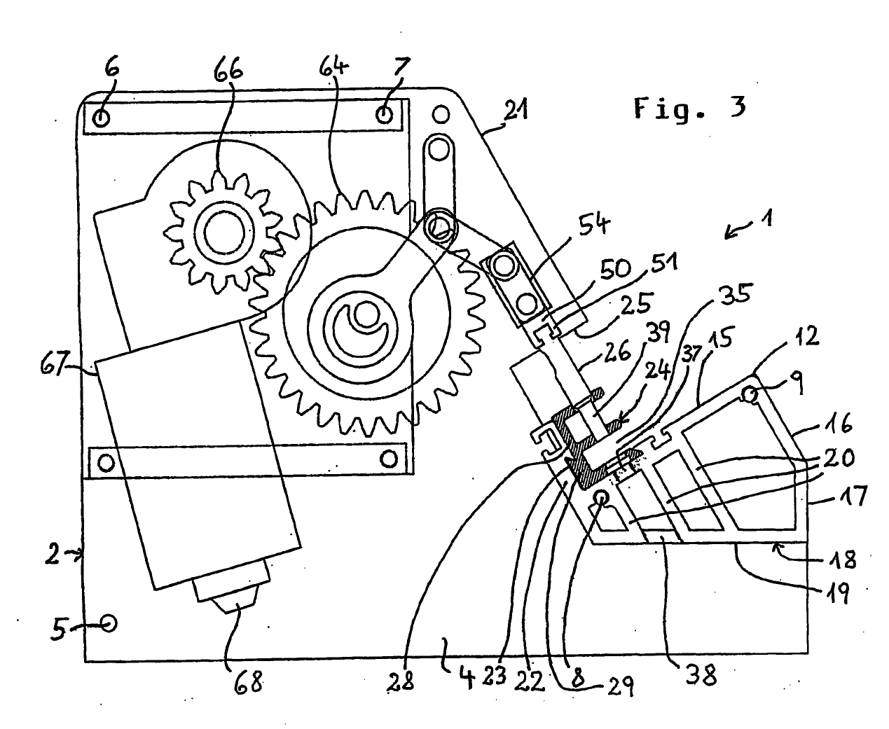

FIG. 3 a view, which corresponds to FIG. 2, a few elucidations and modifications being provided;

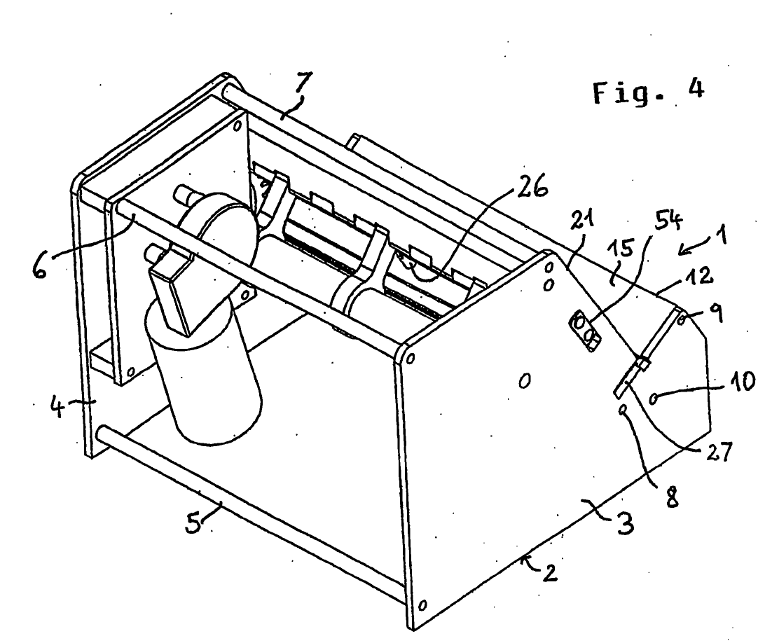

FIG. 4 a perspective view from above and from behind of the punch according FIGS. 1-3 with a protective housing removed in order to illustrate the interior;

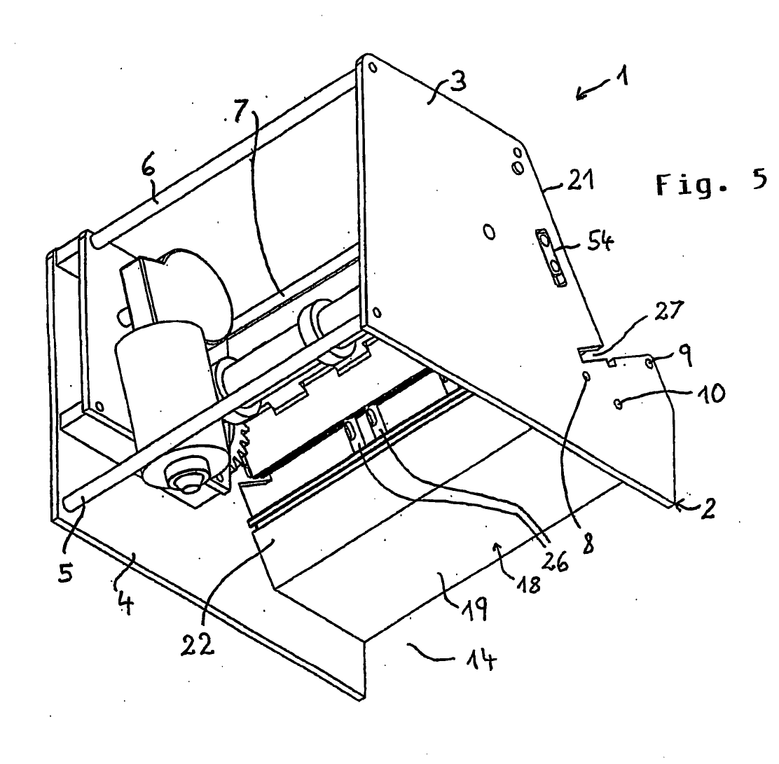

FIG. 5 a perspective view from below and from behind as well as from the right side of the punch according to FIG. 4;

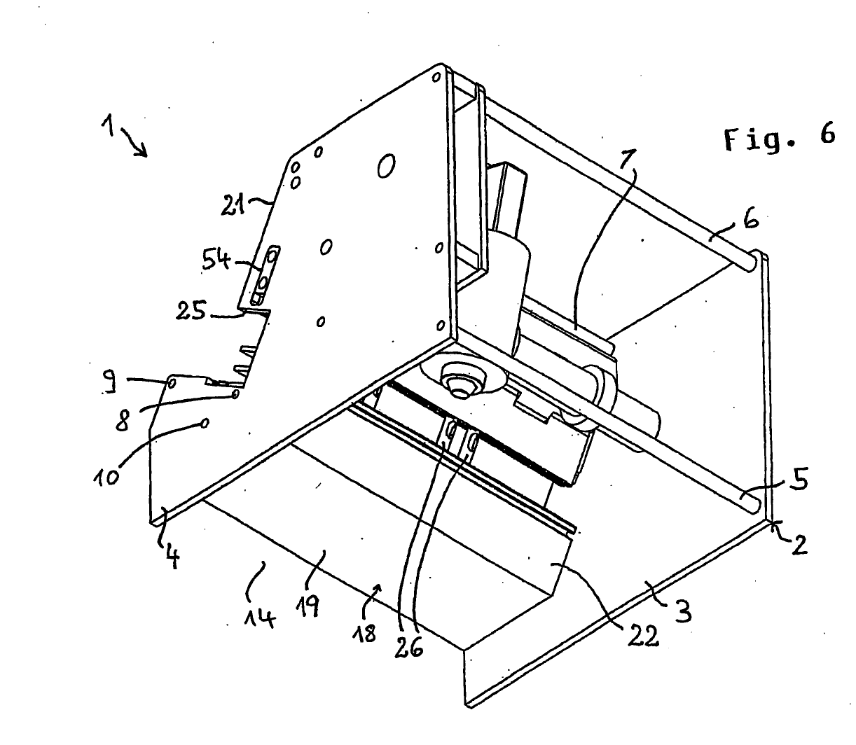

FIG. 6 a view, which corresponds to FIG. 5 but from the left side;

FIG. 7 a perspective view from the left side, from behind and from above of the punch according to FIGS. 4-6;

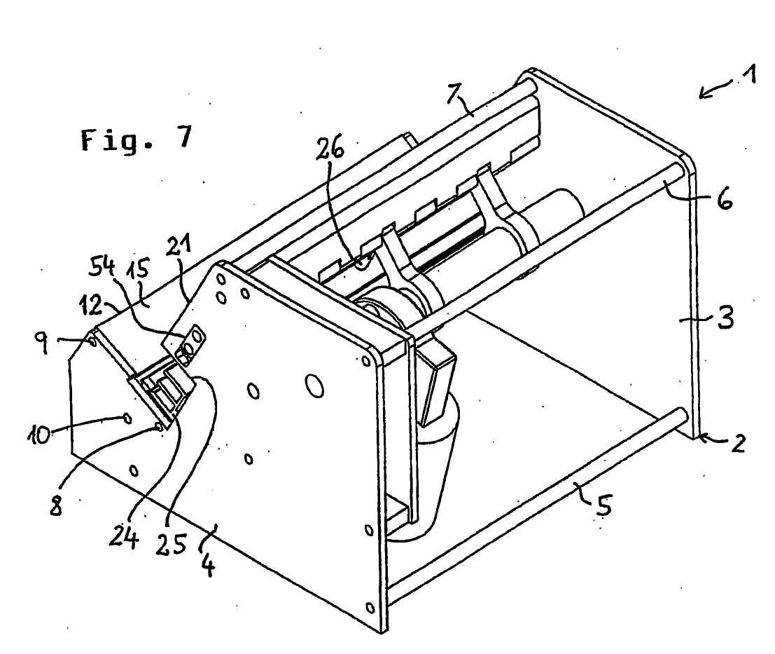

FIG. 8 a view, which corresponds to FIG. 7 but from the front;

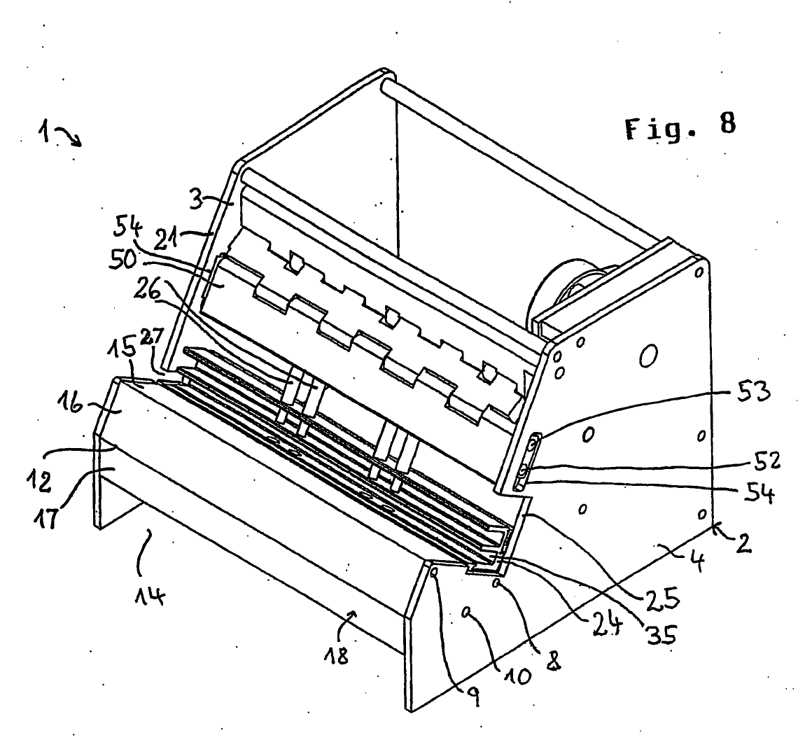

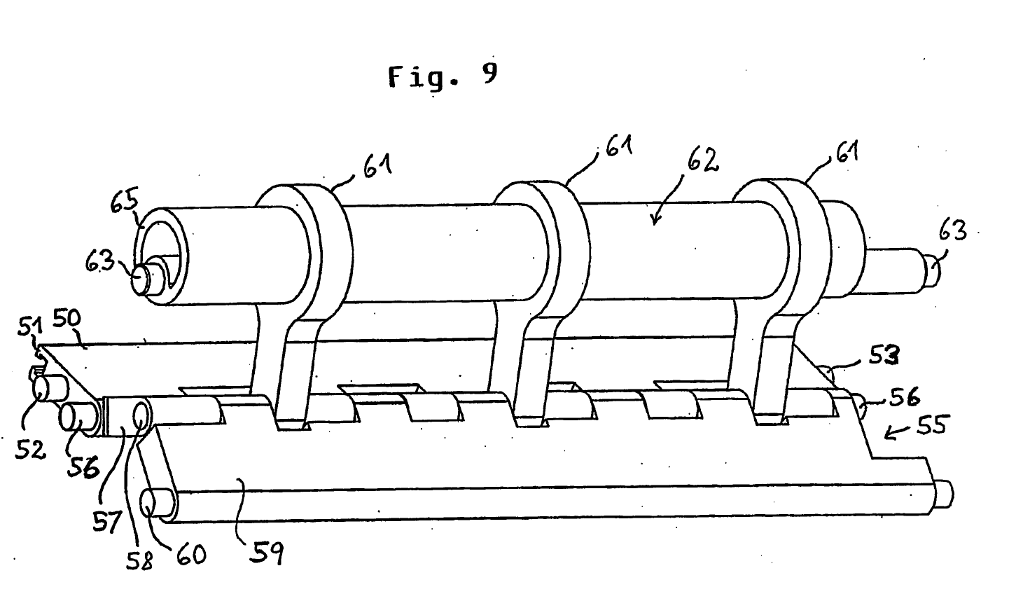

FIG. 9 a perspective view of a crank shaft with driving rods and a lever mechanism according to the invention;

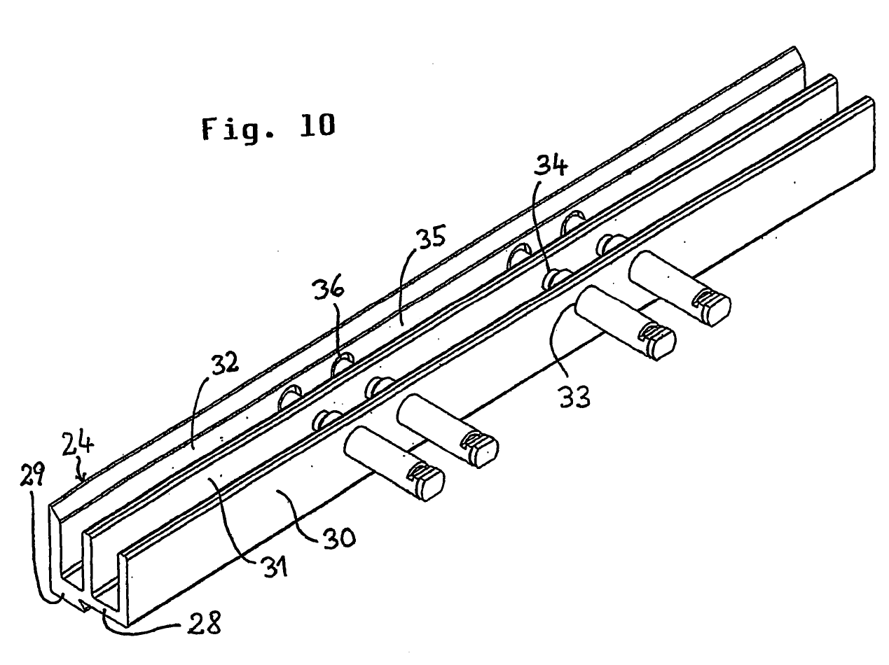

FIG. 10 a perspective view of a punch holder with inserted punch tools;

FIGS. 11 and 12 perspective views from various directions of an assembled punch tool according to the invention; and

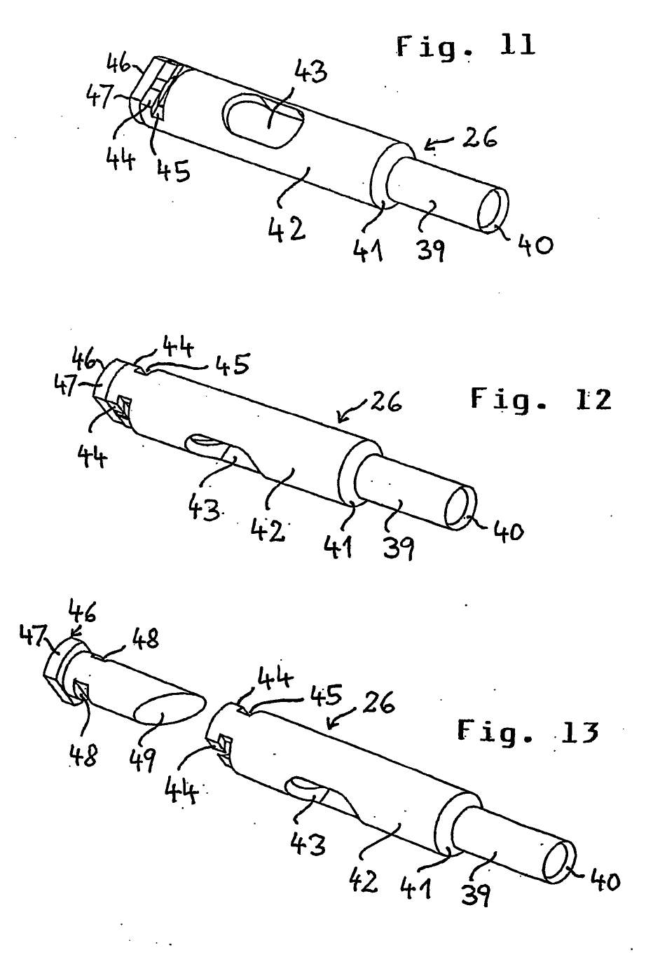

FIG. 13 a perspective view of a disassembled punch tool according to FIGS. 11 and 12.

In the drawings a punch 1 according to the invention is shown in its entirety. The main portions of its shell 2 are two side walls 3 and 4, which are connected to each other by means of bolts or the like 5-10, at least in their rear lower, rear upper and front upper as well as front lower corners, a quite stable unit being obtained, capable of receiving large exterior and interior forces without deformation. The walls and the bolts suitably are made of aluminum or steel. In order to have access to the main part of the interior of the punch the rear side, the upper side and front upper face suitably are covered by a preferably continuous protective housing 11, which can be taken away after the removal of a few conventional mounting means (not shown). The lower side may be open or covered by a separate plate (not shown), whereas the front lower face and the face at the top in front may be covered by a small angle plate 12, whereas the lower front part has an opening 14, designed for insertion and removal of a waste material box 13, designed to collect waste material from the punching.

The front lower portion of the side walls form in a notch-like way a projecting section having an upper side, which is upwardly inclined in the direction from the rear area of the walls and covered by a table portion 15 of said angle plate 12. Said table portion then extends, e.g. designed as two angled sections 16 and 17, downwards up to the opening of the waste material box. Also, table portion 15 can be designed as a separate, above the side wall outline forwardly and upwardly extended portion (see FIG. 2), on which a paper sheaf, which is to be provided with punched holes, will be positioned in its entirety or to a large extent. It is shown in the drawings, that table portion 15 is inclined about 30° in relation to the horizontal plane. The angle may of course vary between 0 and 90°, if that is suitable, possibly with a stepless adjustability of one and the same punch, Portions 12 and 15-17 are made of and supported by respectively a transverse, e.g. aluminum profile 18, made by continuous casting and which inherently and due to its fastening to side walls 3 and 4, e.g. via bolts or the like 8-10, is capable of receiving the large transverse stresses, which the punching, which will be described below, generates. For this purpose the profile is in cross-section closed all around and is provided with a number of cross-walls 20, which connect upper side 15 and lower side 19 to each other. According to e.g. FIG. 3 the rear portion of the profile extends almost, by the obliquely downwardly and forwardly inclined halves, into front side 21 of shell 2 and in this position is provided with a rear profile leg 22, which projects upwards and in parallel with the front side, which profile leg like the upper side, which also constitutes or support table portion 15, is provided with, in its surfaces, which face each other, an e.g. angled dovetail-shaped recess 23, designed to house a from one side insertable W or U profile 24, which is used as a punching pin guide. Within the area of the latter and above it one of side walls 4 is provided with a rectangular notch 25, which allows the lateral insertion and removal of the W profile jointly with punching pins 26, inserted into the W profile. The other side wall 3 lacks such a notch and consequently the W profile unelastically strikes this wall in the final phase of the insertion but is provided with a small recess 27, which allows the punching material to extend through this wall also, in addition to wall 4, in case the length requires this. The side walls and/or the table portion 15 may be provided with guides, known per se, for an automatic longitudinal positioning of the punching material in relation to the punching holes W profile 24 has a web 28 with a longitudinal, e.g. half dovetail-shaped locking list 29, designed to be inserted into dovetail-shaped recess 23 of leg 22, and three legs 30, 31 and 32, of which the upper one 30 is provided with in diameter a somewhat larger bearing hole 33, which corresponds to the in diameter somewhat larger upper portion of punching pins 26, and of which the intermediate leg 31 is provided with in diameter a somewhat smaller bearing hole 34, which corresponds to the in diameter somewhat smaller lower or front portion of punching pins 26. Finally, the lowermost leg 32 suitably inherently is designed as a dovetail-shaped half and designed to be inserted into the recess 23-portion of the table portion 15, the inner side of this leg suitably constituting en extension of the upper side of the table portion, in order to allow sheets of paper, positioned on the table portion, to easily and possibly automatically penetrate into opening 35 between the intermediate leg and the lowermost leg. The latter leg is provided with die holes 36 in front of the holes in the two other legs and possibly housing punching cushions or the like (not shown). Below die holes 36 recesses 37,38 in table portion 15 may be provided, designed to allow punching waste material to reach waste box 13, positioned below.

With special reference to FIGS. 11-13 punching pins 26 include tubes with a front portion 39 with a small diameter and an edge 40 all around the free end. Portion 39 is changed from an outer bevel 41 to a rear portion 42 with a large diameter, which latter portion roughly in the middle is provided with a longitudinally oval breakthrough 43 in the wall, which faces the interior of the punch. The free end of portion 42 is on opposite sides provided with segment-like, mutually parallel plane surfaces 44, which are undercut by suitable grooves 45. In the free end of portion 42 a plug 46 is designed to be inserted, which shape-complementarily fills the interior of this portion and is attached shape-complementarily to the plane surfaces 44 with a head 47 and to grooves 45 with groove 48. Free end of plug 49 is inclined and is located in its inserted position within the area of breakthrough 43. Its task consists of allowing a discharge of squeezed out punching waste material from the tube portion of the punching pin.

Punching pins 26 are inserted, placed in profile 24, jointly with it and in a matched condition according to FIGS. 10-12 through notch 25 and into a punch holding list 50, which shape-complementarily surrounds the grooves and the head of the punching pins (see FIG. 3) with a C-shaped profile 51. List 50 is with its ends, preferably via bearing and guiding pins 52 and 53, positioned at these pins and possibly guiding blocks, e.g. made of a plastic material (not shown), which surrounds the pins, displaceably mounted towards and away from profile 24 in oblong guide openings 54 in side walls 3 and 4. This list belongs to a toggle joint power transmission mechanism 55 and is via a flexible shaft 56 along its upper longitudinal side connected to a upwardly extended intermediate link 57, which in its turn via a flexible shaft 58 is connected to one of the longitudinal sides of an upper link 59, the other upper longitudinal side of which via pivots or the like 60 being pivotally fastened to the side walls within the area of their upper front corners. Flexible shaft 58 is driven, i.e. is moved in a to and fro-motion in relation to front side 21, by means of swinging arms 61, one end of which surrounds said flexible shaft and the other end of which is designed as a bearing eye, which surrounds an eccentric shaft 62, which via, in relation to the larger gear wheel centered pins 63, is mounted in side walls 3 and 4, and which is driven by a larger gear wheel 64, in which eccentric portion 65 of shaft 62 is eccentrically mounted. Said gearwheel 64 is driven in its turn by a smaller gear wheel 66, which preferably via a worm gear 67 is driven by an electric motor 68, preferably a 24 V motor. It is shown to the right in FIG. 9, that the eccentric portion of shaft 62 is somewhat reduced in order to facilitate the insertion of the centered remainder through an intermediate wall (see e.g. FIGS. 4 and 5) and into side wall 4.

In opening 35 between legs 31 and 32 a photoelectric cell (not shown) and/or a mechanical sensor (not shown) suitably is disposed, which can control a punching operation, possibly in combination with time delay relays.

Such a punch functions in the following way: Punching material, i.e. a sheet or a sheaf of paper, plastic, wood or metal sheets, is placed in contact with a lateral stop on table portion 15. The inclination of the latter automatically facilitates an insertion of the punching material in opening 35 or facilitates a complete insertion thereof. By means of said cell, sensor or in another way a signal is sent to motor 68, which is programmed to cause the larger gear wheel 64 to rotate one revolution. The starting position for all of the portions is shown in FIG. 3. Punch holding list 50 and consequently also the punching pins are now maximally pulled upwards and links 57 and 59 include a minimally adjusted angle to each other, e.g. about 120°, whereas eccentric portion 65 is positioned at the side of the eccentric shaft, which is turned away from said links. The motor then starts and causes via the smaller gear wheel the larger gear wheel to rotate one revolution. During the first half of said revolution the eccentric element rotates around its shaft towards said links in order to, in the final phase of said half revolution, have reached a position close to said links, i.e. flexible shaft 58 is displaced towards front side 21 during a continuous increase in the mutual angle between said two links, preferably until the angle approaches about 180°. In this position the punch holding list with the punch pins has been maximally displaced downwards and the punch pins have completely pierced the punching material, the punching waste having been predominantly pressed upwards into the tube-shaped interior of the punch pins and out through the discharge opening and into the waste box, positioned below. A certain portion of the waste material may also penetrate the openings in profile 18 and end up in the waste box in that way. During the second half of the rotational movement of the larger gear wheel the links will return to their starting position with a continuous reduction of their mutual angle.

We have found, that the shown and described lever mechanism can develop relatively large forces despite low voltage and a relatively small motor. Thus, e.g. four holes can easily be punched simultaneously in sheaves of up to 100 sheets. A limit switch and/or other means can guarantee, that the larger gear wheel performs one rotational movement at a time, and then turns off the motor, until a new punching cycle starts. The design of the power transmission mechanism as a joggle joint band hinge, the swinging arms being integrated into the hinge and distributed along its total length, means, that a homogenous “power parcel” is obtained along the entire length of the hinge, which uniformly distributes the punching force. The eccentric shaft allows due to is smooth design along all its length a simple mounting of the swinging arms as well as the driven gear wheel with its eccentric opening. This gear wheel can also be mounted in an optional place along the entire length of the eccentric shaft, i.e. either at one of its ends or between two adjacent swinging arms. Another advantage of the invention resides in the fact, that it without any additional means or measures allows an exchange of punch pins and arbitrary stepless changes in their numbers and mutual distances. Also, changed punch hole sizes and patterns are easy to obtain, simply by changing to other punch pins with adjusted W profiles.

The present invention is not limited to the embodiments described above and/or shown in the accompanying drawings, but it can be modified and supplemented in an arbitrary way within the scope of the inventive idea and the enclosed claims. Thus, W profile 24 can also be designed differently, e.g. as a U profile or as a portion of the shell.

1-10. (canceled)

11. a punch (1) including a shell (2) with an insertion opening (35) for punching material in the form of sheets and sheaves of sheets respectively, which will be provided with punched holes, punching pins (26) in connection with said opening as well as a lever mechanism (55) for the transmission of punching force to the punching pins and for restoring them to a starting position, the punching force being generated by means of an electric motor (68), designed to drive a gear reduction set with a small drive gear (66) and a larger driven gear (64), which is designed to through eccentric action transmit a to and fro-moment to said punching pins, wherein said driven gear (64) one end of an eccentric shaft (62), which extends along the entire width of the punch, is eccentrically mounted with concentric mounting pins (63), positioned at the end, in relation to said driven gear (64), which mounting pins are mounted in the shell (2), in that the eccentric shaft (62) with mounting eyes is surrounded by one end of along this shaft (62) distributed swinging arms (61), the other end of which is mounted on a first flexile shaft (58) between one of the longitudinal sides of an upper, in the shell rotatably fastened link (59) and one to this via said flexible shaft (58) rotatably connected longitudinal side of an intermediate link (57), the other longitudinal side of which via a second flexible shaft (56) is connected to a punch holding list (50), which is mechanically controlled in the shell and displaceable between an upper starting position and a lower punching position and supports said punching pins (26), which are controlled in a punching pin guide profile (24), which includes or is connected to said insertion opening (35), and in that said links are designed to be positioned in an extended or stretched out position in the punching position of the punching pins and a mutual angular position in their resting or starting position.

12. A punch according to claim 11, wherein the shell (2) has two side walls (3) and (4), which are connected to each other through bolts (5-10) in least their rear lower, rear upper and front upper as well as front lower corners in order to obtain a stable unit, which is capable of receiving large exterior and interior forces without deformation, in that the walls and the bolts are make of aluminum and steel respectively, and in that in order to have access to the main portion of the interior of the punch its rear side, upper side and front side are covered by a preferably continuous protective housing (11), which is removable after the removal of fastening means, known per se, whereas the lower side preferably is open or covered by a separate sheet and the front lower front side at the top and at the front upper part is covered by a small angle plate (12), whereas the lowermost front part has an opening (14), designed for an insertion and a removal of a waste material box (13) for collecting waste material from the punching operation.

13. A punch according to claim 12, wherein the front lower parts of the side walls (3,4) in a notch-like way form a projecting section with an upper side, which is inclined upwards in a direction from the rear area of the walls and is covered by a table portion (15) of said angle plate (12), which table portion in connection thereto extends preferably in the form of two angled sections (16) and (17) downwards and up to the opening for the waste material box or in that the table portion (15) is designed as a separate, above the side wall outline forwardly and upwardly extended portion on which e.g. a sheaf of papers, which will be provided with hole punching, in its plane is positioned in its entirety or most of it and in that the table portion (15) is inclined 0-90°, preferably 30°, in relation to a horizontal plane, possibly with a stepless adjustability.

14. A punch according to claim 13, wherein the angle plate (12) and the table portion (15) and said angled portions (16 and 17 respectively) are formed and supported respectively by a transverse aluminum profile (18), obtained by e.g. continuous casting and which per se and in its fastening to the side walls (3) and (4), e.g. via respective bolts or the like (8-10), is able to receive large transverse stresses, for which reason the profile in its cross-section suitably is closed all around and is provided with a number of cross-walls (20), which connect the upper side (15) and the lower side (19) to each other, particularly the rear portion of the profile almost by halves extending into the front side (21) of the shell (2), which is inclined downwards and forwards, and in this area is provided with a rear profile leg (22), which extends upwards in parallel with the front side, which profile leg like the upper side, which also is or supports the table portion (15), is provided in its mutually abutting surfaces with an e.g. angled dovetail-like recess (23), designed to house said punching pin guide profile (24), which is designed as a W- or double U-profile, inserted from one side.

15. A punch according to claim 14, wherein within the area for the punching pin guide profile and above it the one side wall (4) is provided with a rectangular notch (25), which allows the insertion and the removal of the last-mentioned profile in a lateral direction jointly with punching pins (26), inserted in it, whereas the other side wall (3) suitably lacks a similar notch, the punching pin guide profile being designed to hit this wall unelastically in the final phase of the insertion, but provided with a small recess (27), allowing punching material to extend also through this wall, in addition to the wall (4), in case the length requires this, and in that the side walls and/or the table portion (15) are provided with stop means, known per se, for an automatic positioning in the longitudinal direction in relation to the punching holes.

16. A punch according to claim 15, wherein the profile (24) has a web (28) with a locking list (29), which can be moved in a longitudinal direction and e.g. is half dovetail-shaped, and inserted in the dovetail-recess (23) of the leg (22), and three legs (30,31,32), of which the upper one (30) is provided with an in diameter somewhat larger mounting hole (33), which corresponds to the in diameter somewhat larger upper portion of the punching pins (26), and of which the intermediate one (31) is provided with a in diameter somewhat smaller mounting hole (34), which corresponds to the in diameter somewhat smaller or front portion of punching pins (26), whereas the lowermost leg (32) suitably per se is designed as a dovetail-half and designed to be inserted into the recess (23) of the table portion (15), the interior side of this leg suitably being positioned in front of and is an extension of the upper side of the table portion, and the latter leg being provided with die holes (36), positioned in front of the holes in the two other legs and housing possible punching cushions or the like, and in that below the die holes (36) recesses (37,38) are arranged in the table portion (15), allowing punching waste material to be discharged into the waste box (13), positioned below.

17. A punch according to claim 11, wherein the punching pins (26) include tubes with a front portion (39) with a small diameter and an edge (40) all around at the free end, in that said front portion (39) via an outer bevel (41) is changed into a rear portion (42) with a large diameter, which latter portion roughly in the middle of it is provided with a breakthrough (43), oval in its longitudinal direction, in the wall, which faces the interior of the punch, in that the free end of the rear portion (42) on two opposite sides is provided with segment-like, mutually parallel plane surfaces (44), which are undercut by corresponding grooves (45), in that in the free end of this portion (42) a plug (46) is designed to be inserted, which shape-complementarily fills the interior of this portion and is connected shape-complementarily to said plane surfaces (44) having a head (47) and to the grooves (45) with grooves (48), and in that the free end (49) of the plug is inclined and is positioned in an inserted position within the area for the breakthrough (43) in order to allow a discharge of punching waste material, pressed into the tubular portion of the punching pins.

18. A punch according to claim 15, wherein the punching pins (26) are designed to be inserted, introduced into the punching pin guide profile (24) jointly with it and in an assembled condition, through the notch (25) and into said punching holder list (50), which shape-complementarily surrounds the grooves and the head with a C-shaped profile (51) of the punching pins, in that the list (50) with its ends, preferably via mounting and guide pins (52) and (53) at said ends and possibly guide blocks, made of a plastic material, which surrounds said pins, is displaceably mounted in a direction towards and away from the punching pin guide profile (24) in oblong guiding openings (54) in the side walls (3) and (4).

19. A punch according to claim 11, wherein the punching holding list (50) is a part of said lever mechanism, which has the form of a toggle joint power transmission mechanism (55) and is via said second flexible shaft (56) along its upper longitudinal side connected to the upwardly extended intermediate link (57), which in its turn via said first flexible shaft (58) is connected to the one longitudinal side of said upper link (59), the other upper longitudinal side of which via pivots or the like (60) is rotatably fastened to the side walls within the area for their upper foremost corner, in that the first flexible shaft (58) is designed to obtain a to and fro-moment in relation to the front side (21) of said swinging arms (61), the one end of which surrounds this flexible shaft and the other end of which is provided with a mounting eye, which surrounds said eccentric shaft (62), which via said pins (63), which are centric in relation to the large gear wheel, is mounted in the side walls (3 and 4) and which is driven by said large gear wheel (64), in which the eccentric portion (65) of the eccentric shaft (62) is eccentrically mounted, and in that said small gear wheel (66) preferably is driven via a worm gear (67) by said electric motor (68), preferably a 24 V motor, limit switches and/or other means preferably guaranteeing, that the large gear wheel performs only one rotational movement at a time and subsequently stops the motor, until a new punching cycle is initiated.

20. A punch according to claim 16, wherein the opening (35) between the legs (31 and 32) a photoelectric cell and/or a mechanical sensor is arranged, which is designed to control a punching operation, possibly in combination with time delay relays.
